(19) United States
(12) Patent Application Publication
(10) Pub. No.: US 2012/0005759 A1
(43) Pub. Date: Jan. 5, 2012

(54) IMAGE DISPLAY DEVICE, IMAGE DISPLAY METHOD, AND RECORDING MEDIUM

(76) Inventor: Masaru Kawakita, Tokyo (JP)

(21) Appl. No.: 13/255,995

(22) PCT Filed: Mar. 29, 2010
(86) PCT No.: PCT/JP2010/055556

§ 371 Date: Sep. 12, 2011

(30) Foreign Application Priority Data
Mar. 31, 2009 (JP) 2009-086827

(51) Int. Cl. G06F 21/00

(52) U.S. Cl. 726/26

(57) ABSTRACT

When a screen capture operation is monitored and a screen capture operation for instructing acquisition of an image displayed on a display device (13) is conducted, it is determined whether to hide the windows (31, 32, 33) for each application or process. Consequently, the windows (31, 32) requiring an information leak countermeasure are hidden by shading or mosaic-patterning. On the other hand, the window (33) not requiring an information leak countermeasure is displayed normally.

### TECHNICAL FIELD

The present invention relates to an image display device, image display method, and recording medium.

### BACKGROUND ART

An image displayed on a computer monitor is captured by executing a copy operation (screen capture) on the screen. If the image contains confidential information, the confidential information may be leaked.

In order to prevent such confidential information leak, a security system has been proposed in which it is determined whether an image captured by screen capture contains inconvenient information and the display is controlled based on the determination results (for example, see Patent Literature 1).

### TECHNICAL FIELD

Patent Literature 1: Unexamined Japanese Patent Application KOKAI Publication No. 2008-299126.

However, in the security system of Patent Literature 1, key words are used to determine whether inconvenient information is contained and therefore proper display control may not be conducted; a restricted image may be displayed or display restriction may be imposed on an unrestricted image.

The present invention is invented in view of the above problem and an exemplary object of the present invention is to provide an image display device, image display method, and recording medium for conducting suitable display control.

### DISCLOSURE OF INVENTION

In order to achieve the above object, the image display device according to a first exemplary aspect of the present invention comprises a storage means storing multiple application programs; a display control means reading the application programs from the storage means and displaying images corresponding to the application programs on a display part; a determination means determining whether the application program in question is an application program from which acquisition of an image is restricted when an instruction for acquiring an image displayed on the display part is received while the display control means displays images corresponding to the application programs on the display part; and a restriction means restricting acquisition of an image corresponding to the application program in question when the determination means determines that the application program is an application program from which acquisition of an image is restricted.

In order to achieve the above object, the image display device according to a second exemplary aspect of the present invention comprises a storage means storing multiple application programs; a control means reading the application programs from the storage means, generating processes corresponding to the application programs, and displaying images corresponding to the processes on a display part; and a monitoring means monitoring the processes generated by the control means, wherein the monitoring means includes a determination means determining whether the process in question is a process from which acquisition of an image is restricted when an instruction for acquiring an image displayed on the display part is received while the control means displays images corresponding to the processes on the display part; and a restriction means restricting acquisition of an image corresponding to the process in question when the determination means determines that the process is a process from which acquisition of an image is restricted.

In order to achieve the above object, the image display method according to a third exemplary aspect of the present invention comprises a display control step of reading application programs and displaying images corresponding to the application programs on a display part; a determination step of determining whether the application program in question is an application program from which acquisition of an image is restricted when an instruction for acquiring an image displayed on the display part is received while images corresponding to the application programs are displayed on the display part in the display control step; and a restriction step of restricting acquisition of an image corresponding to the application program in question when it is determined in the determination step that the application program is an application program from which acquisition of an image is restricted.

In order to achieve the above object, the recording medium according to a fourth exemplary aspect of the present invention stores programs allowing a computer to function as the following means: a display control means reading application programs and displaying images corresponding to the application programs on a display part; a determination means determining whether the application program in question is an application program from which acquisition of an image is restricted when an instruction for acquiring an image displayed on the display part is received while the display control means displays images corresponding to the application programs on the display part; and a restriction means restricting acquisition of an image corresponding to the application program in question when the determination means determines that the application program is an application program from which acquisition of an image is restricted.

The present invention allows for proper display control while ensuring security capability.

### BRIEF DESCRIPTION OF DRAWINGS

FIG. 1A block diagram showing the configuration of the image display device of the present invention;

FIG. 2A An illustration showing a screen before the hiding procedure for depicting how the present invention is realized;

FIG. 2B An illustration showing a screen after the hiding procedure for depicting how the present invention is realized;

FIG. 3 A functional block diagram of the image display device;

FIG. 4 A sequence chart showing the operation of the image display device;

FIG. 5 A flowchart showing the operation in the process startup procedure;

FIG. 6 A flowchart showing the operation in the hiding procedure; and

FIG. 7 An illustration showing hiding flags.

### BEST MODE FOR CARRYING OUT THE INVENTION

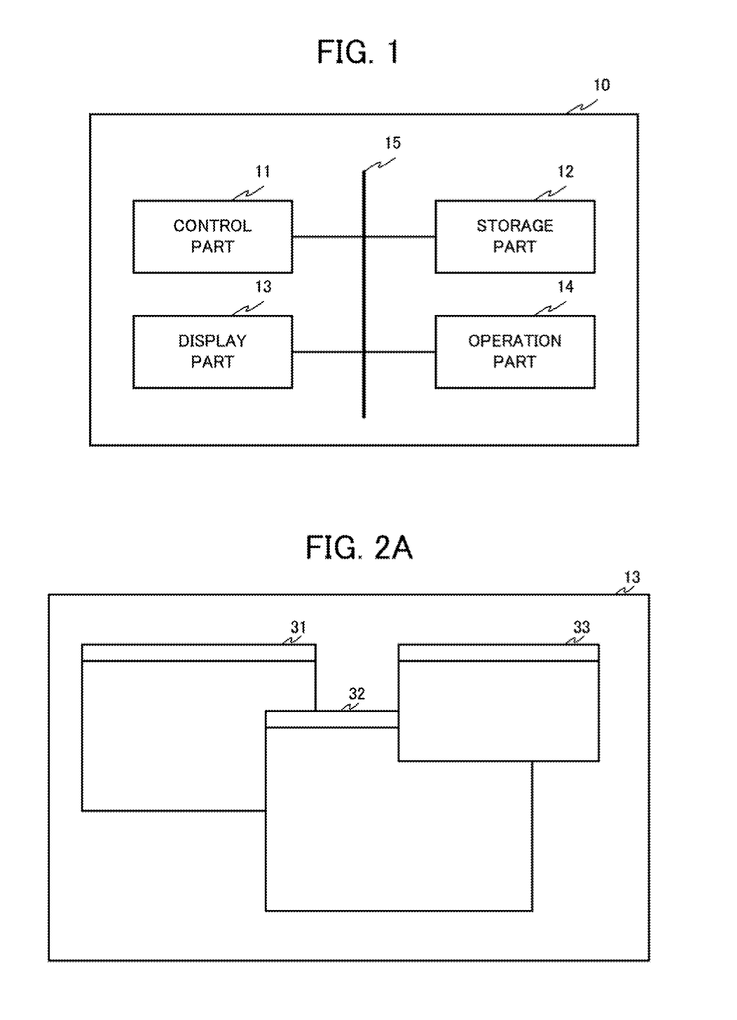

An image display device 10 according to an embodiment of the present invention will be described hereafter with reference to the drawings. FIG. 1 is a block diagram showing the configuration of the image display device 10. As shown in FIG. 1, the image display device 10 comprises a control part 11, a storage part 12, a display part 13, an operation part 14, and a bus 15. Here, the image display device 10 may have another configuration.

The control part 11 is composed of a microprocessor unit and controls the entire operation of the image display device 10. The control part 11 instructs the display part 13 to display a screen containing images corresponding to application programs (processes). When a screen capture operation is conducted on the screen display, the control part 11 executes a hiding procedure to hide images corresponding to processes that should be hidden. Detailed operation will be described later.

The storage part 12 stores various data. The storage part 12 is composed of a hard disc, a RAM (random access memory) as a work area, and a ROM (read only memory) storing operation programs. The storage part 12 stores multiple application programs. The storage part 12 stores programs for realizing the screen hiding function of the present invention. Here, the storage part 12 may be composed of either a memory built in the image display device 10 or a detachable external memory.

The display part 13 is composed of a liquid crystal display and displays various screens under the control of the control part 11. The display part 13 is connected to a video adaptor 26 described later.

The operation part 14 is composed of a keyboard and a mouse and supplies operation signals corresponding to operations with the keyboard and mouse to the control part 11. The image display device 10 is capable of screen capture operation. In other words, the user can conduct a specific operation via the operation part 14 to acquire (copy or print) an image displayed on the display part 13. The bus 15 transfers data between the parts.

The hiding function of the image display device 10 of the present invention will be described hereafter. FIG. 2A shows an exemplary screen displayed on the display part 13 while multiple applications (processes) are active. Here, three windows 31, 32, and 33 corresponding to multiple processes are displayed. If the user conducts a screen capture operation in this state, the windows 31 and 32 to be hidden are shaded or mosaic-patterned for hiding them as shown in FIG. 2B. The windows 31 and 32 are, for example, windows corresponding to processes through which confidential information may be displayed such as Internet browsers.

When this screen image (graphic image) is printed, an image treated in the hiding procedure as shown in FIG. 2B is printed. When the screen image is copied, the image shown in FIG. 2B is copied. When it is pasted to a document file, the image shown in FIG. 2B is pasted. In other words, secondary use of the image is impossible. In FIG. 2B, the window 33 is a window corresponding to a process that does not need to be hidden (such as a calculator application) and therefore the hiding procedure is not executed. As described above, the image display device 10 hides only the display regions (windows) corresponding to processes with potential information leak, whereby an information leak countermeasure is effected only for the necessary parts.

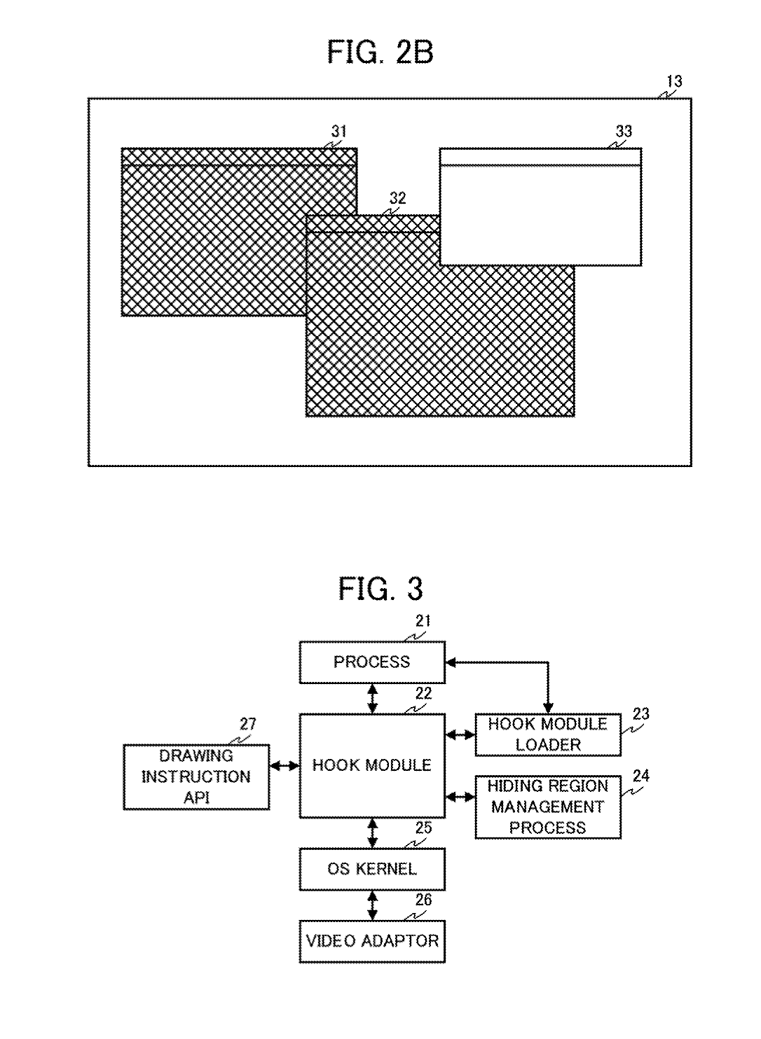

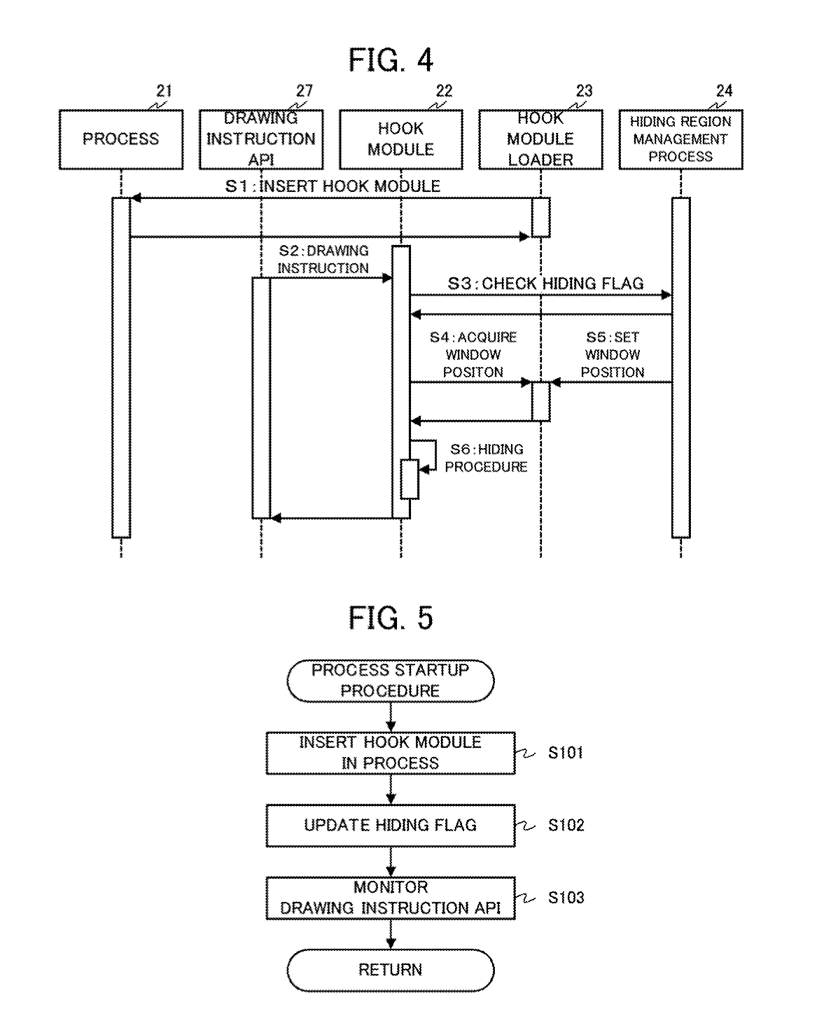

The operation of the image display device 10 for executing the screen hiding procedure will be described hereafter with reference to FIGS. 3 and 4. As shown in FIG. 3, the image display device 10 functions as a process 21, a hook module 22, a hook module loader 23, a hiding region management process 24, an OS kernel 25, a video adaptor 26, and a drawing instruction API (application program interface) 27.

The control part 11 functions as the process 21 by reading application programs stored in the storage part 12. Multiple processes can run on the image display device 10. In such a case, multiple processes corresponding to the same application can run on the image display device 10 (for example, multiple browser windows are activated). Windows corresponding to the processes are displayed on the display part 13.

When the process 21 is started, the hook module 22 determines whether to hide an image corresponding to the process 21 and updates the hiding flag. Furthermore, the hook module 22 monitors the drawing instruction API 127 and executes the hiding procedure on an image to be displayed on the display part 13 when a screen capture operation is conducted and the drawing instruction API 127 is called for.

The hook module loader 23 activates the hook module 22 upon startup of the process 21.

The hiding region management process 24 manages the hiding flag for specifying a process on which the hiding procedure is to be executed and manages the display region of a process on which the hiding procedure is to be executed.

The OS kernel 25 mediates communication between the hook module 22 (software) and the video adaptor 26 (hardware). Receiving a screen-hiding instruction from the hook module 22, the OS kernel 25 transfers the contents of the instruction to the video adaptor 26.

The video adaptor 26 is composed of an LSI chip for image drawing, a memory (VRAM) for holding screen images to be displayed on the display part 13, and a terminal for connection to the display part 13. According to instructions from the video adaptor 26, graphic images are displayed on the display part 13 and some display regions (windows) are hidden.

The drawing instruction API 127 is an interface for drawing images to be displayed on the display part 13. When a screen capture operation is conducted, the drawing instruction API 127 is called for.

The process 21 is monitored by the hook module 22. As shown in FIG. 4, the hook module loader 24 inserts a hook module into the process 21 when the process 21 is started (Sequence S1). If a screen capture operation is conducted while the process 21 is active, the drawing instruction API 127 is called for and the hook module 22 detects it (Sequence S2). Then, the hook module 22 accesses the hiding region management process 23 and checks the hiding flag (Sequence S3). In Sequence S3, the hiding flags of all active processes are checked and it is determined whether at least one process has the hiding flag turned on.

If there is any process having the hiding flag turned on, the hook module 22 sends to the hook module loader 24 a request for acquiring the position of the display region (window) of the process in question on the display part 13 (Sequence S4). On the other hand, the hiding region management process 23 sets the position of the corresponding window in the hook module loader 24 (Sequence S5). Acquiring the position of the corresponding window, the hook module 22 executes the hiding procedure on the position in question (Sequence S6). More specifically, the hook module 22 acquires a screen image from the video memory in the video adaptor 26 via the OS kernel 25, executes the hiding procedure on the screen image, and redraws the screen image treated in the hiding procedure. The hiding procedure is released as the screen capture operation ends.

The hiding procedure can consist of a feathering procedure. In the feathering procedure, for example, of the entire image displayed on the display part 13, the brightness of pixels to be feathered is replaced by the average brightness of pixels near them. Alternatively, in the feathering procedure, a region to be feathered in the entire image is divided into blocks of a given size and the brightness of all pixels in a block is replaced by the average brightness of all pixels in the block.

Detailed operation of the image display device 10 will be described hereafter. FIG. 5 is a flowchart showing the operation in the process startup procedure executed when the process 21 is started. When a given process is started by the user operating the operation part 14, the control part 11 inserts the hook module 22 into the process (Step S101). Subsequently, the control part 11 updates the hiding flag managed by the hiding region management process 24 (Step S102). Here, it is determined whether the started process should be subject to the hiding procedure. If it should be subject to the hiding procedure, the hiding flag is turned on. The hiding flag is associated with the process name as shown in FIG. 7 and stored in the storage part 12.

Whether the started process should be subject to the hiding procedure can be determined by making reference to information stored in the storage part 11. In such a case, information indicating whether the hiding procedure is necessary for each process is stored in the storage part 11 in advance. Furthermore, for a process derived from another process such as a process generated when a new browser window is started through operation on the browser, the hiding flag of the original process can be taken over.

Furthermore, the hiding flag can be turned on assuming that the hiding procedure is always executed when a launcher consisting of a group of icons for starting processes is displayed and a process in the launcher is started.

Following the procedure of Step S102, the control part 11 starts monitoring the drawing instruction API 127 using the hook module 22 (Step S103). Then, the process startup procedure ends.

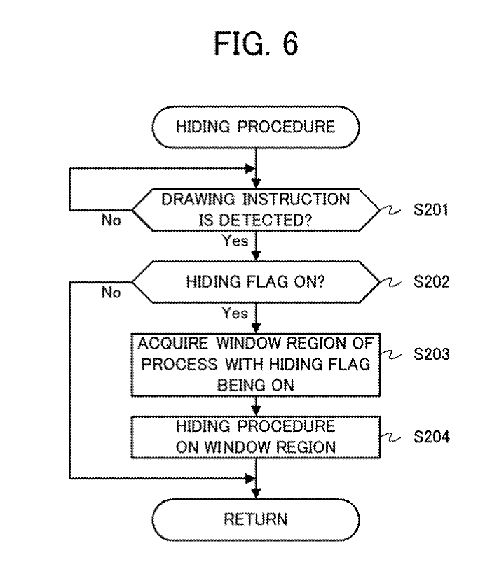

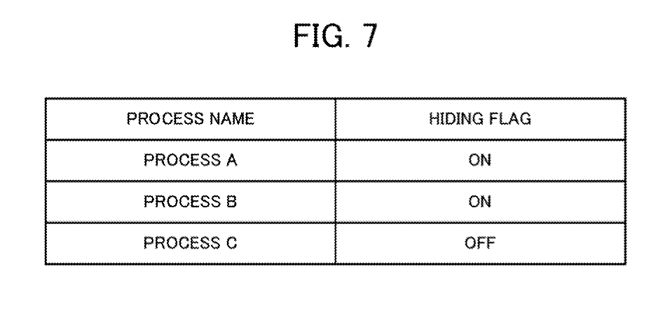

FIG. 6 is a flowchart showing the operation in the hiding procedure executed by the hook module 22. Detecting a drawing instruction from the drawing instruction API 127 (Step S201; Yes), the hook module 22 determines whether any active process has the hiding flag turned on (Step S202). If all hiding flags are off (Step S202; No), the hiding procedure ends. In such a case, screen capture is conducted on the screen as shown in FIG. 2A.

If any hiding flag is on (Step S202; Yes), the hook module 22 acquires the window region of the process having the hiding flag turned on (Step S203). Then, the hook module 22 executes the hiding procedure on the window region (Step S204) and the hiding procedure ends. When the hiding flags are as shown in FIG. 7, screen capture is conducted on the screen as shown in FIG. 2B. Here, the window 31 corresponds to the process A, the window 32 corresponds to the process B, and the window 33 corresponds to the process C.

As described above, the image display device 10 of the present invention can prevent information leak through screen capture. Furthermore, according to the image display device 10 of the present invention, the hiding procedure can be executed only on the parts requiring an information leak countermeasure.

The above embodiment is given by way of example and various applications and modifications can be made to the present invention.

In the above embodiment, an image corresponding to a process (or an application) is an image presenting a window. However, an image corresponding to a process can be any image displayed on a screen.

In the above embodiment, when the hiding procedure is executed on a specific process (or an application), the hiding procedure is executed in regard to all operations including screen display, screen printing, and screen copying. However, the operations in regard to which the hiding procedure is executed can be selected on an arbitrary basis. For example, for preventing data only from being taken out, the hiding procedure may be executed only in regard to screen printing and screen copying, not in regard to screen display.

In the above explanation, for example, the programs for realizing the present invention are stored in advance. They can be acquired from an external storage medium or transferred and stored via a network. Alternatively, the programs can be stored and distributed on a computer readable recording medium such as a flexible disk, CD-ROM (compact disk read only memory), DVD (digital versatile disk), and MO (magnetooptical disk) and installed on another computer to operate as the above means or execute the above steps.

Furthermore, the programs can be stored in a disk device of a server unit on the Internet and, for example, superimposed on carrier waves and downloaded onto a computer to execute them.

The above embodiment can partly or entirely be described as in the following subjunction, but not limited thereto.

(Subjunction 1)

An image display device, comprising:

a storage means storing multiple application programs;

a display control means reading the application programs from the storage means and displaying images corresponding to the application programs on a display part;

a determination means determining whether the application program in question is an application program from which acquisition of an image is restricted when an instruction for acquiring an image displayed on the display part is received while the display control means displays images corresponding to the application programs on the display part; and

a restriction means restricting acquisition of an image corresponding to the application program in question when the determination means determines that the application program is an application program from which acquisition of an image is restricted.

(Subjunction 2)

The image display device according to Subjunction 1, wherein:

the display control means displays images corresponding the application programs in a partial region of the display region of the display part; and

the restriction means restricts acquisition of an image displayed in the partial region when the determination means determines that the application program is an application program from which acquisition of an image is restricted.

(Subjunction 3)

The image display device according to Subjunction 1 or 2, wherein:

the restriction means restricts acquisition of an image corresponding to the application program in question by feathering the image displayed on the display part when the determination means determines that the application program is an application program from which acquisition of an image is restricted.

(Subjunction 4)

The image display device according to any of Subjunction 1 to 3, further comprising a restriction information storage means storing information indicating whether to restrict acquisition of images corresponding to the application programs, wherein:

the determination means determines whether the application program is an application program from which acquisition of an image is restricted based on information stored in the restriction information storage means.

(Subjunction 5)

The image display device according to any of Subjunction 1 to 4, wherein:

the restriction means restricts acquisition of an image corresponding to the application program in question and restricts display of the image on the display part when the determination means determines that the application program is an application program from which acquisition of an image is restricted.

(Subjunction 6)

The image display device according to Subjunction 2, wherein:

the restriction means restricts acquisition of an image displayed in the partial region and restricts display of the image on the display part when the determination means determines that the application program is an application program from which acquisition of an image is restricted.

(Subjunction 7)

The image display device according to Subjunction 3, wherein:

the restriction means restricts acquisition of an image corresponding to the application program in question and restricts display of the image on the display part by feathering the image displayed on the display part when the determination means determines that the application program is an application program from which acquisition of an image is restricted.

(Subjunction 8)

An image display device, comprising:

a storage means storing multiple application programs;

a control means reading the application programs from the storage means, generating processes corresponding to the application programs, and displaying images corresponding to the processes on a display part; and

a monitoring means monitoring the processes generated by the control means,

wherein the monitoring means includes:

a determination means determining whether the process in question is a process from which acquisition of an image is restricted when an instruction for acquiring an image displayed on the display part is received while the control means displays images corresponding to the processes on the display part; and

a restriction means restricting acquisition of an image corresponding to the process in question when the determination means determines that the process is a process from which acquisition of an image is restricted.

(Subjunction 9)

An image display method, comprising:

a display control step of reading application programs and displaying images corresponding to the application programs on a display part;

a determination step of determining whether the application program in question is an application program from which acquisition of an image is restricted when an instruction for acquiring an image displayed on the display part is received while images corresponding to the application programs are displayed on the display part in the display control step; and

a restriction step of restricting acquisition of an image corresponding to the application program in question when it is determined in the determination step that the application program is an application program from which acquisition of an image is restricted.

(Subjunction 10)

A recording medium storing programs allowing a computer to function as the following means:

a display control means reading application programs and displaying images corresponding to the application programs on a display part;

a determination means determining whether the application program in question is an application program from which acquisition of an image is restricted when an instruction for acquiring an image displayed on the display part is received while the display control means displays images corresponding to the application programs on the display part; and

a restriction means restricting acquisition of an image corresponding to the application program in question when the determination means determines that the application program is an application program from which acquisition of an image is restricted.

The present invention is based on Japanese Patent Application No. 2009-086827 filed on Mar. 31, 2009, of which the specification, scope of claims, and drawings are entirely incorporated herein by reference.

### INDUSTRIAL APPLICABILITY

The present invention is applicable to any information processing device dealing with confidential information.

### LEGEND

10 image display device
11 control part
12 storage part
13 display part
14 operation part
15 bus
21 process
22 hook module
23 hiding region management process
24 hook module loader
25 OS kernel
26 video adaptor

1. An image display device, comprising:
a storage unit storing multiple application programs;
a display control unit reading said application programs from said storage unit and displaying images corresponding to the application programs on a display part;
a determination unit determining whether the application program in question is an application program from which acquisition of an image is restricted when an instruction for acquiring an image displayed on the display part is received while said display control unit displays images corresponding to said application programs on said display part; and
a restriction unit restricting acquisition of an image corresponding to the application program in question when said determination unit determines that said application program is an application program from which acquisition of an image is restricted.

2. The image display device according to claim 1, wherein:
said display control unit displays images corresponding said application programs in a partial region of the display region of the display part; and
said restriction unit restricts acquisition of an image displayed in said partial region when said determination unit determines that said application program is an application program from which acquisition of an image is restricted.

3. The image display device according to claim 1, wherein:
said restriction unit restricts acquisition of an image corresponding to the application program in question by feathering the image displayed on said display part when said determination unit determines that said application program is an application program from which acquisition of an image is restricted.

4. The image display device according to claim 1, further comprising a restriction information storage unit storing information indicating whether to restrict acquisition of images corresponding to said application programs, wherein:
said determination unit determines whether said application program is an application program from which acquisition of an image is restricted based on information stored in said restriction information storage unit.

5. The image display device according to claim 1, wherein:
said restriction unit restricts acquisition of an image corresponding to the application program in question and restricts display of the image on said display part when said determination unit determines that said application program is an application program from which acquisition of an image is restricted.

6. The image display device according to claim 2, wherein:
said restriction unit restricts acquisition of an image displayed in said partial region and restricts display of the image on said display part when said determination unit determines that said application program is an application program from which acquisition of an image is restricted.

7. The image display device according to claim 3, wherein:
said restriction unit restricts acquisition of an image-corresponding to the application program in question and restricts display of the image on said display part by feathering the image displayed on said display part when said determination unit determines that said application program is an application program from which acquisition of an image is restricted.

8. An image display device, comprising:
a storage unit storing multiple application programs;
a control unit reading said application programs from said storage unit, generating processes corresponding to the application programs, and displaying images corresponding to the processes on a display part; and
a monitoring unit monitoring the processes generated by said control unit,
wherein said monitoring unit includes:
a determination unit determining whether the process in question is a process from which acquisition of an image is restricted when an instruction for acquiring an image displayed on the display part is received while said control unit displays images corresponding to said processes on said display part; and
a restriction unit restricting acquisition of an image corresponding to the process in question when said determination unit determines that said process is a process from which acquisition of an image is restricted.

9. An image display method, comprising:
a display control step of reading application programs and displaying images corresponding to the application programs on a display part;
a determination step of determining whether the application program in question is an application program from which acquisition of an image is restricted when an instruction for acquiring an image displayed on the display part is received while images corresponding to said application programs are displayed on said display part in said display control step; and
a restriction step of restricting acquisition of an image corresponding to the application program in question when it is determined in said determination step that said application program is an application program from which acquisition of an image is restricted.

10. (canceled)
